(19) United States
(12) Patent Application Publication
(10) Pub. No.: US 2003/0063172 A1
(43) Pub. Date: Apr. 3, 2003

(54) Ink jet recording apparatus

(75) Inventors: Kazuhiko Ohtsu, Mishima-shi (JP); Koichi Adachi, Shimizu-shi (JP); Ryozo Akiyama, Mishima-shi (JP); Minoru Koyata, Takata-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/243,096

(22) Filed: Sep. 12, 2002

(30) Foreign Application Priority Data
Sep. 13, 2001 (JP) 2001-277737
Mar. 11, 2002 (JP) 2002-64689

(51) Int. Cl. B41J 2/01

(52) U.S. Cl. 347/102

(57) ABSTRACT

An ink jet recording apparatus variably controls a time from the hitting of a UV-ray curable ink, for example, UV-ink after being discharged from an ink Jet recording head on a recording medium to the irradiation of UV-ray to the ink. That is, UV-rays are irradiated to the ink so as to be the permeability amount of the ink obtained by the Bristow method more than Vr and less than 0.7 Vmax, preferably, more than Vr and less than 0.3 Vmax, after the transfer of the ink to the recording medium (Tw), whereby lowering of the image density, and occurrence of odor caused in a case of excess permeability can be prevented.

### BACKGROUND OF THE INVENTION

1. Field of the Invention

This invention relates to an ink jet recording apparatus for selectively flying ink droplets to record characters or images on a recording medium.

2. Discussion of the Background

Inks used for ink jet recording apparatus include aqueous inks, oily inks and solvent inks. Such various types of inks are properly selected while considering the kinds of recording media on which such inks are deposited for recording and the types of fixing mechanisms in the ink jet recording apparatus.

Aqueous inks and oily inks are in common with each other in that they are generally used for water absorbing recording media. On the contrary, the fixing mechanisms are different between the aqueous inks and the oily inks. Upon fixing, the aqueous inks are fixed by the effects of evaporation of a solvent and permeability into the recording medium, whereas the oily inks tend to be fixed predominantly by the permeability to the recording media exclusively. Since they are in common with each other in that both kinds of inks are fixed by permeability to the recording medium, it is extremely difficult to fix on less water absorbing recording media both in the aqueous ink and the oily ink.

In view of the above, the solvent ink has often been used for less water absorbing recording media. However, since the solvent ink is fixed along with evaporation of the solvent, it requires a system for recovering volatile organic compound formed upon evaporation of the solvent.

In addition, since the solvent ink has high volatility, it often clogs an ink nozzle formed in an orifice plate by the evaporative drying of the solvent at a high frequency, often causing charging failure and requires frequent maintenance of spitting or purging.

In view of the foregoings, it has been noted for the use of an electromagnetic radiation curable ink as typically represented by UV-ink (UV-ray curable ink) in recent years Referring, for example, to the UV-ink, the UV-ink comprises a photopolymerizable oligomer, a photopolymerizable monomer, a photopolymerization initiator, and a colorant composed of a organic or inorganic pigments as a main composition. In such a UV-ink, radicals are generated from the photopolymerization initiator by UV-ray irradiation, which attack to activate the reactive monomers and oligomers. Subsequently, activated reactive monomers and oligomers are reacted with each other into a polymer, by which the ink is fixed on a recording medium. Therefore, reliable fixing can be realized also to a recording medium which is less water absorbing.

Further, reaction of the UV-ink by the irradiation of UV-rays is taken place in an extremely short period of time and it does not form volatile organic compounds.

Further, the UV-ink has extremely low volatility and scarcely causes clogging by evaporative drying in an ink nozzle formed to an orifice plate which would bring about a problem in the solvent ink.

Such excellent fixing mechanism, low volatility and low viscosity of the UV-ink have been evaluated and a demand has been increased for an ink jet recording system by using a UV-ink to a less water absorbing recording medium in recent years.

Problems of such conventional technique will be explained below.

Different from the aqueous ink or oily ink, it is possible in the UV-ink to increase the viscosity or cure the ink to control permeability into or lateral spreading on the recording medium by irradiating UV-rays at a predetermined timing after deposition of the ink discharged from an ink jet recording head onto a recording medium, thereby providing a characteristic capable of attaining desired fixing condition (image quality).

However, since setting of predetermined conditions for satisfying image density, fixing property of the ink to the recording medium, reduction of residual uncured ink (reduction of odor), that is, setting for the timing of irradiating UV-rays after hitting of the ink on the recording medium to cure and fix the ink fluctuates greatly depending on the physical property of the ink (viscosity, surface tension, etc.) or the kind of the recording medium (characteristic), there is a problem that reliable setting for desired conditions is difficult.

In view of the above, when an electromagnetic radiation curable ink, for example, an UV-ink is cured by the irradiation of UV-rays as electromagnetic radiation rays, thereby forming images on the recording medium, various disadvantages tend to occur such that no desired image density can be obtained, the fixing property is poor tending to cause peeling and odors are released from the recording medium after forming the images, and their control is extremely difficult.

### SUMMARY OF THE INVENTION

This invention intends to facilitate setting for the timing of irradiating UV rays after ejecting an ink on a recording medium to cure and fix the ink.

This invention further intends to obtain a desired image density when images are formed on a recording medium by using an electromagnetic radiation curable ink, for example, a UV-ink.

This invention further intends to improve the fixing property of an ink to a recording medium when images are formed on the recording medium by using an electromagnetic radiation curable ink, for example, a UV-ink.

This invention further intends to eliminate odors from a recording medium after forming images when images are formed to the recording medium by using an electromagnetic radiation curable ink, for example, a UV-ink.

In accordance with this invention, the time from the deposition of an electromagnetic radiation curable ink on a recording medium after being discharged from an ink jet recording head to the irradiation of electromagnetic radiation rays to the ink is variably controlled so as to satisfy a relation with respect to an optimal permeability amount Vx of an ink into a recording medium as:

Vr≦Vx≦0.7 Vmax

Preferably,

Vr≦Vx≦0.3 Vmax

where

Vr: roughness index defined by a Bristow method,

Vx: amount for the sum of an amount of ink filled in dented space of a medium surface and a permeability amount into a recording medium, and

Vmax: amount of ink droplets deposited on the recording medium.

Further, Vr which is “roughness index defined by a Bristow method” is an amount of ink intruding into the unevenness on the surface of the recording medium till the ink wets the recording medium, which means an amount measured by the Bristow method. Meanings for such terms are in common throughout the specification.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a model view showing the state of an ink droplet discharged from a not illustrated ink recording head when it flies toward the recording medium, then hits on a recording medium and then permeates into the recording medium along with time;

FIG. 2 is a model view for explaining a method of a liquid absorption test by a Bristow method;

FIG. 3 is a model view for explaining a liquid absorption test head box by the Bristow method;

FIG. 4 is a graph illustrating a relation of an ink contact time to a recording medium and an ink transfer amount (absorption amount) to a recording medium in a liquid absorption test by the Bristow method;

FIG. 5 is a graph illustrating a relation between a permeability amount of an ink to a recording medium and an image density of images formed on the recording medium;

FIG. 6 is a model view for explaining peeling evaluation standards by a cross-cut method according to JIS;

FIG. 7 is a graph illustrating a relation between a permeability amount of an ink to a recording medium and a fixing property of images formed on the recording medium;

FIG. 8 is a graph illustrating a relation between an absorption coefficient and a circularity coefficient;

FIG. 9 is a side elevational view of an ink jet recording apparatus,

FIG. 10 is a perspective view thereof;

FIG. 11 is a functional block diagram showing a hardware structure of an ink jet recording apparatus;

FIG. 12 is a graph illustrating a relations between an emission wavelength and a relative output in various kinds of bulbs; and

FIG. 13 is a graph illustrating an example of a illumination profile of an UV-ray irradiation apparatus.

### DETAILED DESCRIPTION OF THE PREFERRED EMBODIMENT

Examples of the invention are to be explained with reference to the drawings.

At first, the principle of the invention in this example is to be explained and then details for the example are to be explained.

1. Principle of the Present Invention

The inventors of the present application have attempted various approaches for solving the problem, in a case of forming images on a recording medium by irradiating UV-rays as electromagnetic radiation rays to an electromagnetic radiation curable ink, for example, an UV-ink to cure the same, that desired image density can not be obtained sometimes, fixing property is deteriorated, or odors may sometimes be formed from the recording medium after forming the images.

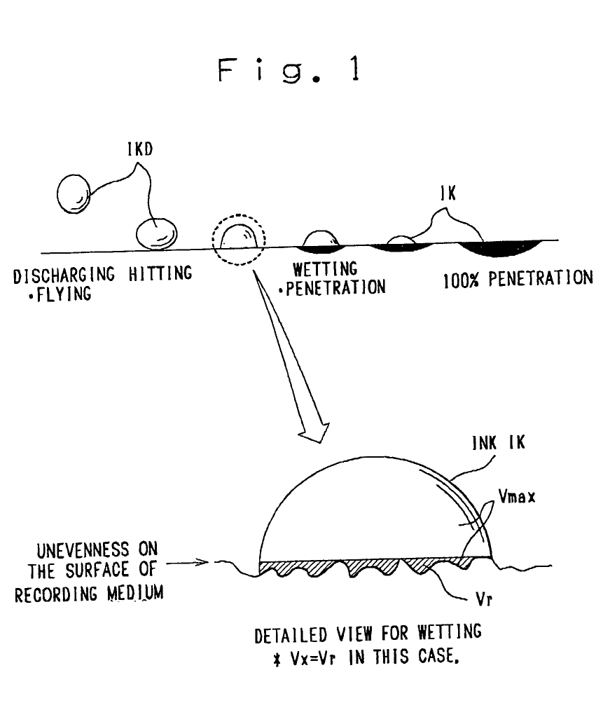

FIG. 1 is a model view illustrating the state of an ink droplet discharged from a not illustrated ink recording head when it is flies toward a recording medium, then hits on a recording medium and then permeates into the recording medium along with time.

As shown in FIG. 1, an ink droplet IKD caused to fly toward a recording medium 1 hits on the recording medium 1, then gradually permeates and, finally, entirely permeates into the recording medium 1. In the process described above, when an electromagnetic radiation curable ink, for example, a UV-ink (UV-ray curable ink) is used as an ink IK, the ink IK is cured by the irradiation of UV-rays after hitting on the recording medium 1 and then fixed on the recording medium 1.

The inventors of the present application have tried a liquid hygroscopic test by using a Bristow method in order to determine the timing for UV-ray irradiation during the period after hitting of the ink IK to the recording medium 1 to 100% permeability into the recording medium 1 in FIG. 1 for obtaining a good result.

(Bristow Method)

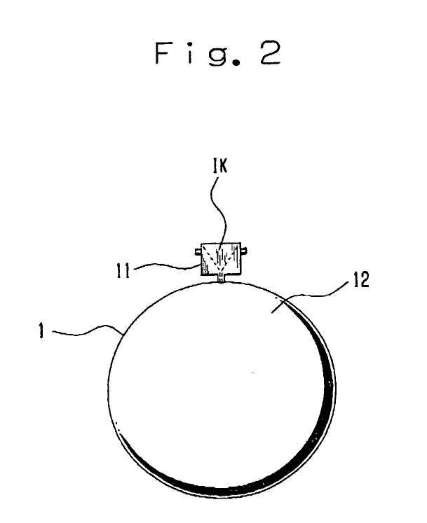

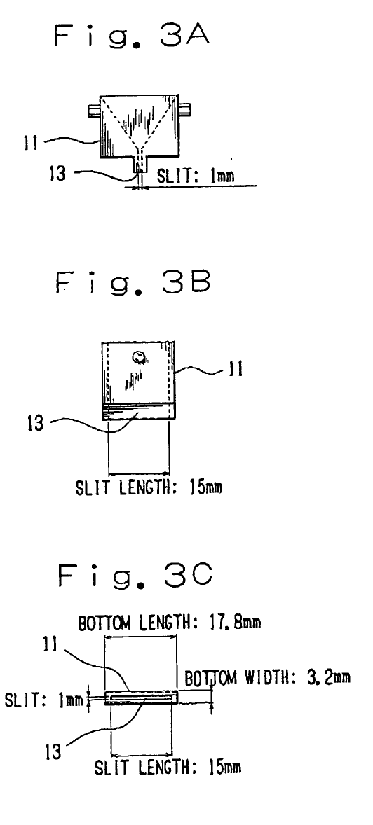

FIG. 2 is a model view for explaining a method of liquid absorption test by the Bristow method and FIG. 3 is a model view explaining a liquid absorption test head box by the Bristow method.

The Bristow method referred to herein is a liquid absorption test method for paper and paper board according to J. Tappi Paper Pulp Test Method No. 51-81 as the standards of Paper Pulp Technology Association in Japan. The Lucus-Washburn's equation:

<h≈{(rγcosθ·t)/2η}^{½}>

where

h: permeability depth of liquid into paper

γ: surface tension of liquid

θ: angle of contact

η: viscosity of liquid has been known so far.

Considering the Lucus-Washburn's equation, the transfer amount of a liquid per unit area after contact of the liquid with paper is estimated to be in proportion with the square root of the time. Then, it can be said that the Bristow method is a method of evaluating dynamic absorption characteristics of paper in a short period of time (ms) by utilizing the relation described above.

Measurement by the Bristow method is conducted by using a Bristow tester as shown in FIG. 2. The Bristow tester is a tester developed by Bristow. Measurement by the Bristow method using the Bristow tester is conducted, generally, by containing a predetermined liquid, an ink IK in this case, into a head box 11, transferring the contained ink IK to a recording medium 1 as a test piece appended on the periphery of a rotational drum 12 and determining the transfer amount thereof. That is, the ink IK contained in the head box 11 is released through a slit 13 formed in the head box 11 to the outside and transfers to the recording medium 11 appended to the dram 12. Then, measurement by the Bristow method can be conducted by determining the transfer amount of the ink IK to the recording medium 1. According to the Bristow method practiced by the inventors of the present application, the transfer amount of the ink IK to the recording medium 1 for a contact time of 0.004 sec to 2 sec can be measured by changing the rotational speed of the dram 12.

The Bristow tester is to be described more in details. The rotational dram 12 is made, for example, of aluminum. The rotational speed of the dram 12 can be changed to an optional surface speed within a range of the speed of 0.5 to 250 mm/s by combination with a not illustrated transmission. As shown in FIG. 3, the head box 11 has a structure in which a slit 13 of 1.0 mm width is formed for a length of 15 mm. The head box 11 is formed by using a material such as chromium plated brass. The head box 11 is located such that the bottom formed with the slit 13 is urged to the recording medium 1 as a specimen appended on the dram 12. The urging force in this case is a pressure, for example, at about 0.1 Mpa (1.02 kgf/cm²).

Measurement by the Bristow method using the Bristow tester is to be explained more in details. The principle by the Bristow method comprises transferring a liquid at various speeds from the head box 11 to the recording medium 1 on the dram 12, applying an equation:

V=Vr+Ka×(T−Tw)^{½}

to a relation between the square root of an absorption time T (ms) and a transfer amount (ml/m²), determining intercept Vr (ml/m²), gradient Ka (ml/m^{2·}ms^{½}) and Tw (ms).

In this case, Vr has no concerns at all with the permeability of the liquid but depends on the unevenness on the surface of the recording medium, which is referred to as a roughness index. Ka is an indication representing the absorption speed which is concerned, for example, with an angle of contact between liquid and paper, a capillary tube radius of paper, viscosity of liquid, and surface tension, which is referred to as an absorption coefficient. Tw is referred to as a wetting time which is observed when the angle of contact between liquid and paper is large as in the case of water, and is a time from the wetting of the surface of paper fibers with a liquid till starting of absorption. Usually, Tw=0 in a case of an oil and permeability starts simultaneously with contact of the liquid.

$$\begin{matrix}Absorption time T ( ms ) = slit width ( mm ) \times 1000 \text{/} paper \\ transfer speed ( mm \text{/} s ) :\end{matrix}$$

is obtained.

Further, the transfer amount V of the liquid is calculated, based on the liquid addition amount X to the head box 11 (usually 40 μl), the length after transfer left by the liquid till it completely transfers to the paper surface as the recording medium 1 (trace length) A (mm) , and the slit length (15 mm), according to the following equation.

$$\begin{matrix}Liquid transfer amount V ( ml \text{/} {m}^{2} ) = X ( μ l ) \times 1000 \text{/} A ( mm ) \times \\ slit length ( mm )\end{matrix}$$

Measurement is conducted as described below.

(1) Speed setting is conducted.

As the surface speed of the dram 12, 0.5 mm/s, 1.25 mm/s, 2.5 mm/s, 5 mm/s, 12.5 mm/s, 25 mm/s, 50 mm/s and 250 mm/s are usually used.

(2) The recording medium 1 as a test specimen is in close contact with a dram 12 and fixed, for example, by a cellophane tape.

(3) 40 μl of liquid is injected in the head box 11 by using a microsyringe.

(4) The head box 11 is quietly placed down on a rotating recording medium.

(5) The dram 12 is rotated continuously till the liquid in the head box 11 is completely absorbed to the recording medium 1. The head box 11 is raised when the trace is eliminated.

(6) The recording medium 1 is detached from the dram 12 and the trace length is measured on mm unit.

(7) The procedures described above are repeated at each of speeds.

(8) The test at each of the speeds is conducted three times or more.

Based on the result of measurement obtained by the processes (1)-(8) described above, the transfer amount V (ml/m²) of the liquid is plotted relative to the square root (√ms) of the absorption time T (ms) to prepare an absorption curve. The absorption coefficient is determined as a gradient of a linear segment obtained by the least square method based on each of the points measured for absorption time exceeding the wet time.

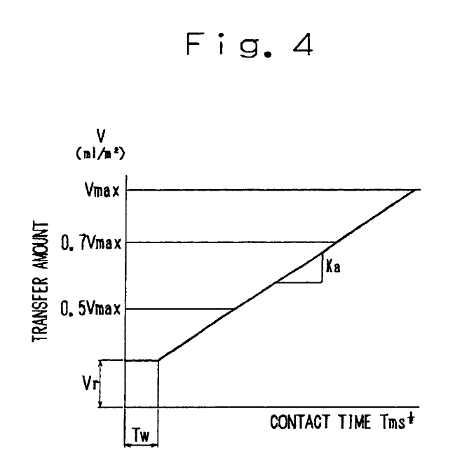

FIG. 4 is a graph illustrating a relation between the contact time of an ink to a recording medium and the transfer amount (permeability amount and absorption amount) of the ink to the recording medium in the liquid absorption test by the Bristow method. The graph is generally referred to as an absorption curve in which the abscissa represents the contact time on the scale of square root of time. Then, the gradient of the graph as the absorption curve defines an absorption coefficient (Ka). Further, the ink transfer amount at 0 sec of the contact time is referred to as a roughness index (Vr), which represents the amount of the ink intruding into the unevenness on the paper surface. That is, considering a case that an ink droplet IKD hits on the recording medium 1 referring to FIG. 1 (detailed view for wetting), the amount of the ink intruding into the unevenness of the paper surface corresponds to the amount of the ink IK intruding into the slight unevenness on the surface of the recording medium 1 as shown in FIG. 1 (detailed view for wetting) during period from the hitting of the ink IK on the surface of the recording medium 1 till wetting. Upon practicing the Bristow method, the initial contact process of the ink IK to the recording medium 1 includes a time (Tw) where absorption of the ink IK to the recording medium 1 does not occur and the time is referred to as an ink wet time. Usually, Tw=0 in a case of an oil and permeability starts simultaneously with contact of the liquid. This is a time required to wet the recording medium with the ink IK.

The graph in FIG. 4 is represented as;

V=Vr+Ka×(T−Tw)^{½}

where

V: transfer amount

Vr: roughness index

Ka: absorption coefficient

T: absorption time

Tw: wet time, respectively.

The ink absorption coefficient (Ka) is determined depending on the surface state of the recording medium 1, the physical property of the ink Ik, and the wettability of the ink Ik and the recording medium 1. It is judged that as Ka is larger, the permeability rate of the ink Ik to the recording medium 1 is higher and as Ka is smaller, the permeability rate, is lower.

<Image Density >

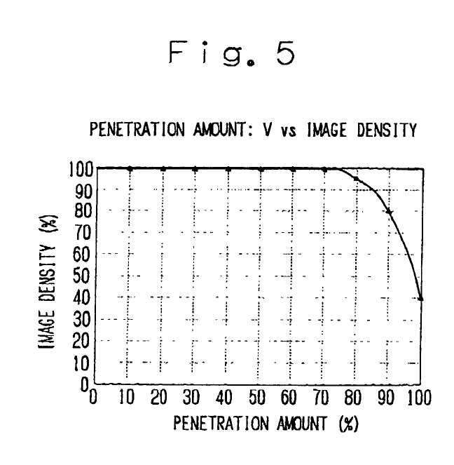

FIG. 5 is a graph illustrating a relation between the permeability amount of an ink IK to a recording medium 1 and an image density of images formed to the recording medium 1. The permeability amount means the transfer amount referred to in the Bristow-method.

The inventors of present application irradiated UV-rays to an uncured ink IK showing the permeability state in the recording medium 1 at 10% interval from 10% to 100%, cured the ink, and examined ink density. As a result, as apparent from the graph shown in FIG. 5, it was found that the state for the image density at 100% was maintained in a case where the permeability amount of the ink IK to the recording medium 1 was 70% or less, whereas the image density was lowered as the permeability amount exceeded 70% and the image density was lowered to about 40% at the permeability amount of 100%.

Accordingly, from the result shown in FIG. 5, it can be seen that the permeability amount of the ink IK to the recording medium 1 should be 70% or less in order to maintain a good image density.

<Fixing Property >

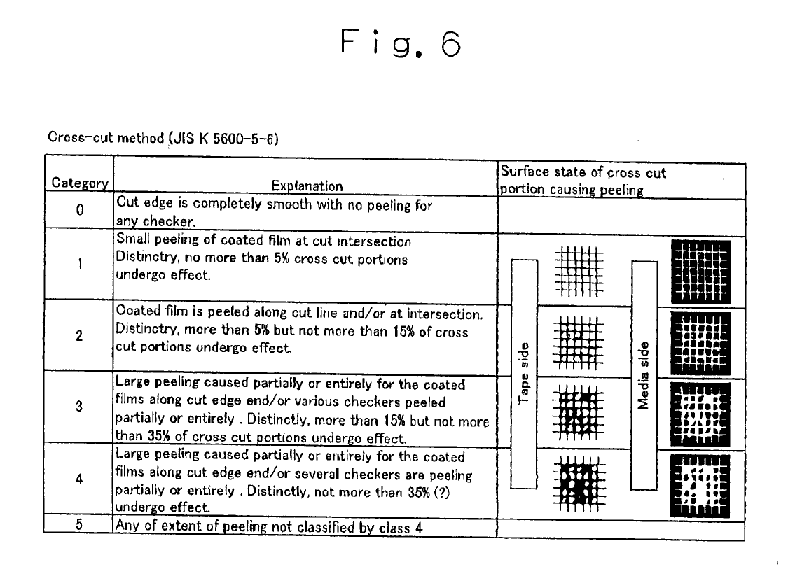

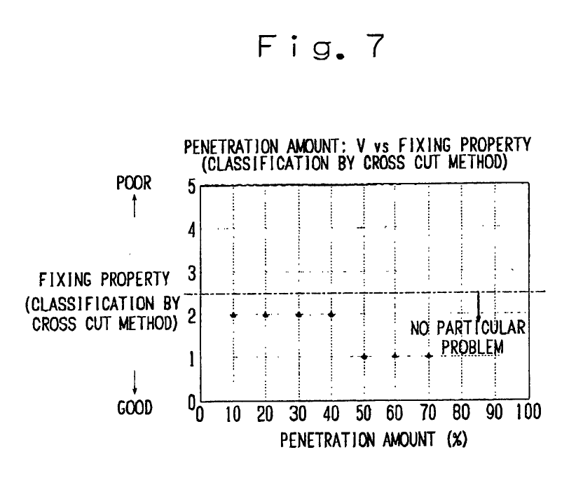

FIG. 6 is a model view for explaining peeling evaluation standards by a cross-cut method according to JIS and FIG. 7 is a graph illustrating a relation between the permeability amount of an ink Ik into a recording medium 1 and the fixing property of images formed on the recording medium 1.

The fixing property of the cured ink film was evaluated with reference to a test for deposition as the mechanical property of a coated film according to the cross-cut method (JIS K 5600-5-6) specified in JIS. That is, for the cured ink film coated and cured on the recording medium 1, a check-like pattern is cut at about 1 mm distance by using a cutter knife such that only the cured ink film is scratched. In this case, it is adapted such that scratches do not reach the recording medium 1. Then, after appending an adhesive tape so as to be adhered on an object, the appended adhesive tape was peeled slowly while pulling in a direction at about 45° relative to the surface of the object and the state for both the adhesive tape and the recording medium 1 was evaluated. In this case, Scotch Clear tape CP-18 manufactured by 3M Corp. was used as the adhesive tape. In the cross-cut method, six step evaluation from 0 to 5 was conducted as illustrated in FIG. 6.

The inventors of the present application irradiated UV-rays to an uncured ink IK showing the permeability state to the recording medium 1 in a range from 10% to 70% at 10% interval, cured the ink and evaluated the fixing property thereof by the cross-cut method. As a result, as shown in FIG. 7, it can been seen that the evaluation for the fixing property is “2” which corresponds to class 2 in the cross-cut method in a case where the permeability amount is 10% to 40%, and the evaluation for the fixing property is “1” which corresponds to class 1 in the cross-cut method in a case where the permeability amount is 50% to 70%.

Then, as shown in FIG. 6, since both the evaluation for “1” and “2” of the fixing property (cross cut method classification) are at the level with no practical problem, it can be seen that adhesion with no trouble can be obtained within a range of the permeability amount from 10% to 70%.

<Odor >

Table 1 shows a relation between the permeability amount of an ink into a recording medium and the result of functional odor judgement regarding the odor of recording media on which images are formed.

TABLE 1

| Permeability | | | | | | | | | | | |
|---|---|---|---|---|---|---|---|---|---|---|---|
| amount (%) | 0 | 10 | 20 | 30 | 40 | 50 | 60 | 70 | 80 | 90 | 100 |
| Functional | ◯ | ◯ | ◯ | ◯ | Δ | X | X | X | X | X | X |
| evaluation | | | | | | | | | | | |
| judgement | | | | | | | | | | | |

The inventors of the present application irradiated UV-rays to an uncured ink IK showing the permeability state in the recording medium 1 at 10% internal in a range from 0% to 100%, cured the ink and evaluated the odor of the recording medium 1. The evaluation method was conducted by functional smell evaluation of causing several panelers to smell the odor of the recording medium 1 on which an ink IK was cured and fixed and left for 24 hours and evaluating the odor by the three steps that the odor is:

◯: not disturbing,

Δ: somewhat disturbing, and

×: disturbing.

As shown in FIG. 1, in a case where the ink IK is an electromagnetic radiation curable ink such as an UV-ink, when UV-rays (electromagnetic radiation rays) are irradiated to the ink IK penetrating into the recording medium 1, only the surface of the ink IK is cured and it is difficult to cure the ink IK as far as the region permeated into the recording medium 1. Therefore, as the permeability amount to the recording medium 1 increases, residual uncured region in the ink IK increases. Then, in the residual uncured region of the ink IK, monomers contained in the ink IK release odors.

With the reasons described above, when the permeability amount of the ink IK to the recording medium 1 is 30% or less, it gives an evaluation that the odor is not disturbing (◯). On the other hand, when the permeability amount is 40%, it gives an evaluation that the odor is somewhat disturbing (Δ) and when the permeability amount exceeds 50%, it gives an evaluation that the odor is disturbing (×).

Accordingly, from the result shown in Table 1, it can be seen that the permeability amount of the ink IK to the recording medium 1 has to be 30% or less in order to suppress the odor in the recording medium 1 after recording.

<Absorption Coefficient Ka >

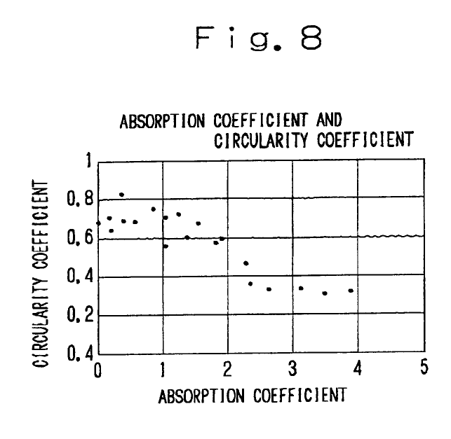

FIG. 8 is a graph illustrating a relation between an absorption coefficient and a circularity coefficient.

The inventors of the present application examined a relation between the absorption coefficient Ka and the circularity of dots formed by an ink IK with respect to the absorption coefficient Ka that is the slope of the graph of an absorption curve in the Bristow method described above.

For this purpose, the inventors have conducted a feathering test for a combination of 20 kinds of samples sampled optimally. At first, for examining feathering, dot images were formed on a recording medium 1. For the images, the experiment was conducted by forming the images at a timing at which the ink somewhat permeates provisionally into the recording medium 1, specifically, by setting the time from the hitting of the ink IK on the recording medium 1 to the cure of the ink IK by the irradiation of the UV-rays to 2 sec. Then, the thus prepared dot images were measured by a dot analyzer (Image Evaluation Device) manufactured by Oji Keisoku Kikai Co., to determine the circularity coefficient. In the measurement, ten dots were measured and averaged, and the circularity coefficient was used as a numerical value for judging the adequacy of the feathering.

The circularity coefficient is a numerical value derived from the value for the area and the peripheral length of the dot, which means:

Circularity coefficient=4π×dot area/(dot peripheral length)².

As the circularity coefficient approaches 1, the circularity is higher, whereas as it decreases below 1, the circularity is poor, and it can be judged that the degree of deformation of the circle is large based on the feathering. As the judging standards for the adequacy based on the result described above, it can be evaluated that the feathering is small when the coefficient is 0.7 or more. Then, based on the graph in FIG. 8, it can be seen that the circularity of 0.7 or more corresponds to a range of the absorption coefficient Ka of 0 to 1.0 ml/(m²√ms).

Accordingly, from the result shown in FIG. 8, it can be seen that combination of the recording medium 1 and the ink IK is preferably selected such that the absorption coefficient Ka is within a range from 0 to 1.0 ml/ (m²√ms).

<Optimal Permeability Amount of ink IK Penetrating into Recording Medium 1 >

From the result of the experiment described above, the inventors of the present application assumed an optimal permeability amount that the ink IK permeate into the recording medium 1. Assuming the optimal permeability amount as Vx, the optimal permeability amount Vx is desirably a value capable of satisfying the relation:

Vr≦Vx≦0.7 Vmax (1)

or

Vr≦Vx≦0.3 Vmax (2)

(refer to FIG. 4).

In the relation (1) and the relation (2) described above, Vr means the amount of the ink IK intruding into the unevenness on the surface of the recording medium 1 (roughness index) as shown in FIG. 1 (detailed view for wetting) in a range from hitting of the ink IK to the surface of the recording medium 1 till wetting thereof, when considering hitting of the ink droplet IKD on the recording medium 1 with reference to FIG. 1 (detailed view for wetting). According to the Bristow method, the initial contact process of the ink IK with the recording medium 1 includes a time (Tw) where the absorption of the ink IK to the recording medium 1 does not occur, which is a time required for the recording medium 1 to be wetted with the ink IK. The portion of the time is referred to as an ink wet time. In the relation (1) and the relation (2) above, the amount of the ink IK intruding into the unevenness on the surface of the recording medium 1 during the contact time is defined as a roughness index.

In the relation (1) and the relation (2), Vmax defines the amount of ink droplet IKD deposited on the recording medium 1. That is, this is a permeability amount per unit area in a case where the ink droplet IKD entirely permeates into the recording medium 1. In this case, the ink amount V per unit area (ml/m²) is represented as:

V=v×10⁻⁹/{(25400/X)×10⁻⁶}²

where

x: resolution (Xdpi)

v: amount of ink liquid IKD (v pl).

For example, when v=14 pl, V is about 7.8 ml/m². Accordingly, Vmax in this case is also about 7.8 ml/m².

Then, the relation (1) above defines an optimal permeability amount Vx capable of solving the problem in the image density and, the relation (2) above defines not only the image density but also the optimal permeability amount Vx capable of also solving the problem of the odor.

2. Example

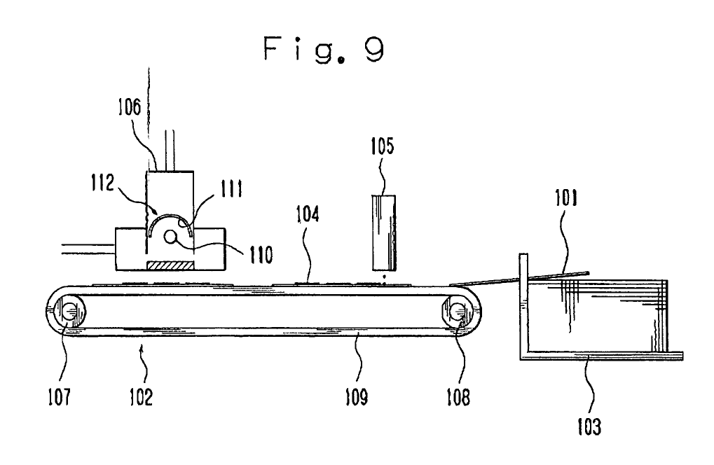

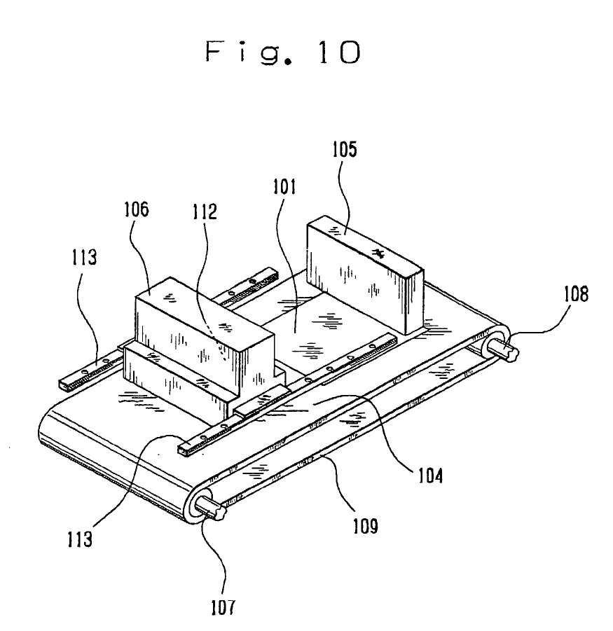

FIG. 9 is a side elevational view of an ink jet recording apparatus and FIG. 10 is a perspective view thereof. A medium conveying section 102 of a conveyor belt structure is disposed for conveying a recording medium 101, and a medium supply section 103 for supplying a recording medium 101 to the medium conveying section 102 is disposed. Then, in a medium conveying channel 104 for conveying the recording medium 101 by the medium conveying section 102, are located an ink jet recording head 105 and an UV-ray irradiation device 106 as an electromagnetic radiation ray irradiation section in the order nearer to the medium supply section 103.

The medium conveying section 102 constitutes a recording medium conveying mechanism having a structure where a conveyor belt 109 is extended between a driving roller 107 and a driven roller 108, the conveyor belt 109 is moved turnably by the rotation of the driving roller 107 which is driven rotationally by a power from a not illustrated driving source, thereby conveying the recording medium 101 situated on the conveyor belt 109.

The medium supply section 103 has a structure of stacking and accommodating plural recording media 101 and picking up and supplying the uppermost recording medium 1 toward the medium conveying section 102.

The ink jet recording head 105 is a line type head of a structure for discharging and flying ink droplets formed with a UV-ray curable ink selectively from not illustrated plural nozzles arranged on a line. In this example, there is no particular restriction on the type of the mechanism for jetting and flying the ink. Such an ink jet recording head 105 is disposed with the ink discharging end thereof being opposed to the medium conveying channel 104.

The UV-ray irradiation device 106 has a structure of irradiating an emission light from bulbs 110 of UV-lamps such as a mercury lamps or metal halide lamps directly or by reflecting with a reflection plate 111 onto a recording medium 101 conveyed on the medium conveying channel 104. The UV-ray irradiation device 106 is one of modes of electromagnetic-radiation ray irradiation section, and the UV-ray irradiation device 106 for irradiation of UV-rays is used as the electromagnetic radiation ray irradiation section in this example. This is because the ink jet recording head 105 in this example uses a UV-ray curable ink and discharges the ink toward the recording medium 101.

Further, as shown in FIG. 10, in the UV-ray irradiation device 106, the bulb 110 and the reflection plate 111 are constituted as a UV-ray irradiation unit 112, and the UV-ray irradiation unit 112 is slidably held on a pair of rails 113 located along the medium conveying channel 104 for the recording medium 111. Then, the UV-ray irradiation device 106 is provided with a not-illustrated actuator for applying a driving force to the UV-ray irradiation unit 112 to slide the same. The moving mechanism is constituted herein.

Then, description is to be made to an ink to be discharged out of the ink jet recording head 105. Compared with a printing ink used usually as a printing ink (1.000 to 10,000 mPa·s) the ink viscosity in this case has to be lowered greatly (30 mPa·s or less : viscosity at 25° C.). Then, for lowering the viscosity, a monomer having the required predetermined performance, for example,

(a) good dilution property

(b) not hindering adhesion and curability

(c) with less odor

(d) high boiling point or flashing point, and

(e) high stability is incorporated. As the additive capable of lowering the viscosity while satisfying various kinds of required performances for the ink, one or two of the following monomers are added by a predetermined amount to lower the viscosity in this example:

Ethoxy diethylene glycol acrylate,

Hexane diol diacrylate,

Phenoxy diethylene glycol acrylate,

Neopentyl glycol diacrylate and the like.

Further, together with the monomer described above, oligomers, for example, polyester acrylate, epoxy acrylate or urethane acrylate is used.

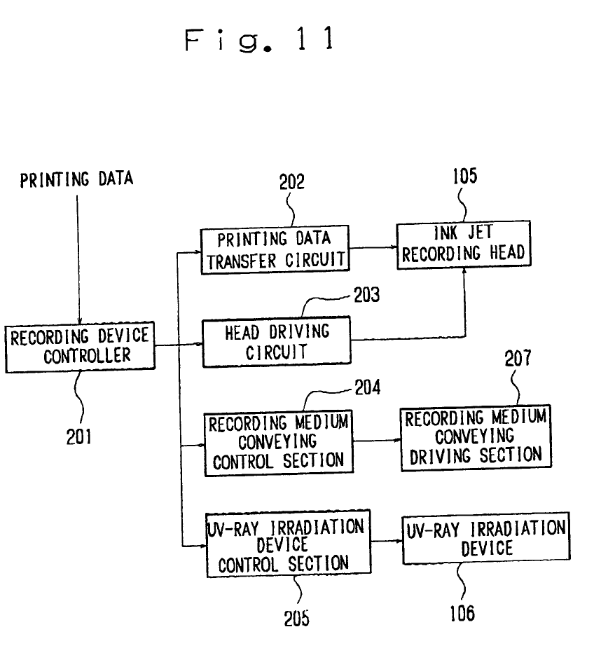

FIG. 11 is a block diagram showing a hard ware structure of an ink jet recording apparatus.

The ink jet recording apparatus of this example comprises the medium conveying section 102, the medium supply section 103, the ink jet recording head 105, and the UV-ray irradiation device 106 described above as the main constituent factors and each of the sections is basically put to driving control by the control from a microprocessor. Accordingly, the ink jet recording apparatus comprises CPU as a microprocessor and ROM and RAM (all of them are not illustrated) connected by way of busses to CPU to construct a microcomputer, and each of sections are put to driving control in accordance with operation programs stored in ROM or RAM. Under the driving control described above, the medium conveying section 102, the medium supply section 103, the ink jet recording head 105, and the UV-ray irradiation device 106 operate as described below.

At first, printing data are transferred to a recording device controller 201 and the printing data is sent by the recording device controller 201 to a printing data printing circuit 202, and a driving signal for printing is sent to a head driving circuit 203. The head driving circuit 203 drives the ink jet recording head 105, and the ink jet recording head 105 discharges an ink as an ink droplets from a not illustrated nozzle in accordance with the printing data transferred to the printing data transfer circuit 202.

In this case, the recording device controller 201 sends driving signals also to a recording medium conveying section 204 and a UV-ray radiation irradiation device control section 205. Thus, the driving roller 107 is driven to turn the conveyor belt 109 and convey the recording medium 101 situated on the conveyor belt 109 and, at the same time, the bulb 110 is energized to light up in the UV-ray irradiation device 106. Then, images are formed in accordance with the printing data on the recording medium 101 by the combination of the movement of the recording medium 101 in the subscanning direction by the conveyance and the selective ink discharge from the ink jet recording head 105 where the not illustrated nozzles are arranged on the line in the main operation direction. When the thus formed images (that is, the ink) are transferred as far as the position for the UV-ray irradiation device 106, they are irradiated with UV-rays from the illumination light from the bulb 110, cured and fixed on the recording medium 101.

In this example, the UV-ray irradiation unit 112 in the UV ray irradiation device 106 is driven by the UV-irradiation device control section 205, to optimize the distance between the ink jet recording head 105 and the UV-ray irradiation device 106. Thus, the function of the electromagnetic ray radiation control means is executed.

That is, in this example, in order to ensure the image quality (image density, fixing property, and reduction of odor by residual uncured ink), setting for the ink curing timing by the irradiation of UV-rays (setting for the permeability amount per unit area) is conducted while coping with fluctuation of the permeability amount of the ink depending on the characteristics of the ink (viscosity, surface tension, or the like) and the characteristics of the recording medium (surface wettability, surface porosity, etc). For attaining them, in this example, the permeability characteristics of the ink to the recording medium 101 (absorption curve) by the combination of the ink and the recording medium 101 determined by measurement of the Bristow method, and the image density, the fixing property and the odor are evaluated, respectively, to optimize the distance between the ink jet recording head 5 and the UV-ray irradiation device 106 so as to obtain an optimum UV-ray irradiation timing (setting for the optimum permeability amount per unit area). In this example, the optimal permeability amount Vx of the ink to the recording medium 101 is defined so as to satisfy the relation of the relation (1) or the relation (2) described above, that is;

Vr≦Vx≦0.7 Vmax (1)

Vr≦Vx≦0.3 Vmax (2).

In this example, the distance between the ink jet recording head 105 and the UV-ray irradiation device 106 is optimized so as to set the permeability amount Vx satisfying the relation (2) for narrower range.

For setting the distance between the ink jet recording head 105 and the UV-ray irradiation device 106 described above, the UV-ray irradiation unit 112 is driven to move and the distance between the ink jet recording head 105 and the UV-ray irradiation unit 112 is set in this example. As the base for the moving amount, the positional information for the UV-ray irradiation unit 112 calculated on the result for determining the relation (2) above regarding the combination of the ink and the recording medium 101 is stored in the RAM of the microcomputer not illustrated. Then, when information for the combination of the ink and the recording medium 101 is inputted, the UV-ray irradiation device 106 is moved by driving control of the UV-ray irradiation device control section 205 in accordance with the positional information for the UV-ray irradiation unit 112 stored in the RAM.

As another example, the conveying speed for the recording medium 101 by the recording medium conveying section 207 may be controlled to set the permeability amount Vx capable of satisfying the relation (2) while fixing the position for the UV-ray irradiation unit 112.

As a further embodiment, the permeability amount Vx capable of satisfying the relation (2) may be set by combining the movement of the UV-ray irradiation unit 112 and the change of the conveying speed for the recording medium 101 by the recording medium conveying driving section 207.

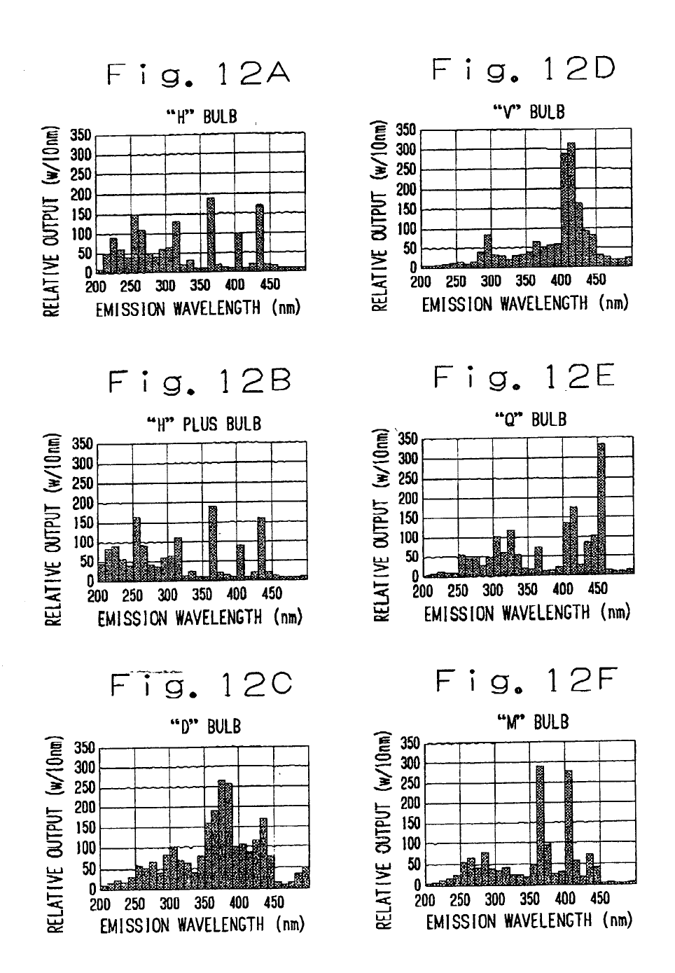

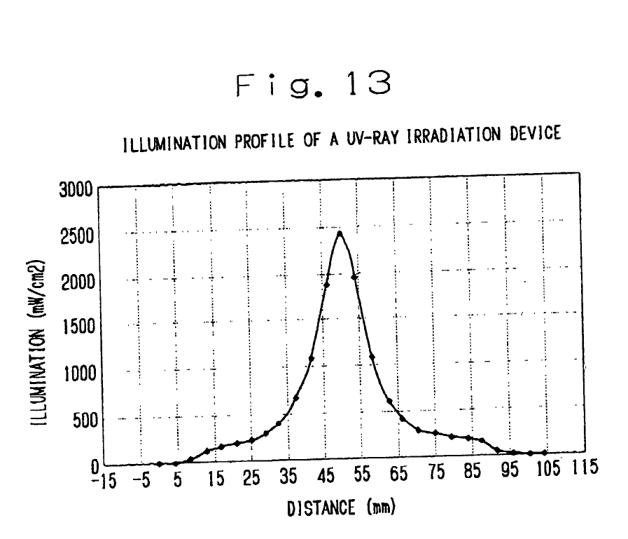

FIG. 12 is a graph showing a relation between the emission wavelength and the relative output in each kind of bulbs, and FIG. 13 is a graph illustrating an illumination profile of a UV-ray irradiation device.

As apparent from FIG. 12, relation between the emission wavelength and relative output, and the illumination profile are generally different for bulb 110, with respect to manufacturers or products. Accordingly, the illumination profile illustrated in FIG. 13 is different with respect to each bulb 110. Then, regarding the concept for the distance and the time that the ink of the images recorded by the ink jet recording head 105 reaches the UV-ray irradiation position in the UV-ray irradiation device 106, it should be defined as to what is a position at which the ink reaches the UV-ray irradiation position. In this example, the position, that is, the position at which the ink reaches the UV-ray irradiation position is assumed as a position reached by the illumination profile of the bulb 110. The illumination profile of the bulb 110 in this case is a position at 1/e² from the peak illumination position of the bulb, that is, the top illumination in a certain illumination profile.

3. Experimental Example

The inventors of the present application have actually practiced the example. As a result, satisfactory result could be obtained. Conditions for the example are as shown below.

Ink: UV-ray curable ink (UV-ink for ink jet recording)

Recording medium: coated paper for printing (basis weight: 104.7 g/m²)

Conveying speed: 25 m/min

Bulb for UV-ray irradiation: “D” bulb (manufactured by Fusion UV Systems Japan Co.)

Peak illumination: about 2500 mw/cm²

Accumulated light amount; about 500 J/cm²

Time from ink deposition to UV radiation for optimal recording medium: 0.2-2 sec

Obviously, numerous modifications and variations of the present invention are possible in light of the above teachings. It is therefore to be understood that within the scope of the appended claims, the invention may be practiced otherwise than as specifically described herein.

The present application is based on Japanese Priority Documents P2001-277737 filed on Sep. 13, 2001 and P2002-64689 filed on Mar. 11, 2002, the content of which is incorporated herein by references

What is claims is:

1. An ink jet recording apparatus, comprising:
an ink jet recording head positioned relatively moveably to a recording medium for selectively causing ink droplets to fly;
an electromagnetic radiation ray irradiation section for irradiating electromagnetic radiation rays to an electromagnetic radiation ray curable ink discharged from the ink jet recording head and deposited on the recording medium so as to cure the ink; and
an electromagnetic radiation ray irradiation time control means for controlling the time from the deposition of the ink on the recording medium after being discharged from the ink jet recording head till irradiation of electromagnetic radiation rays to the ink by the electromagnetic radiation irradiation section such that the optimal permeability amount Vx when the ink permeates into the recording medium can satisfy the relation:
Vr≦Vx≦0.7 Vmax
where Vr: roughness index defined by a Bristow method,
Vx: sum for the amount of an ink filling the dented spaces of a medium surface and a permeability amount to the recording medium, and
Vmax: amount of ink droplets deposited on the recording medium.

2. An ink jet recording apparatus according to claim 1, wherein the electromagnetic radiation ray irradiation control time control means controls the time from the deposition of the ink to the recording medium after being discharged from the ink jet recording head till irradiation of electromagnetic radiation rays to the ink by the electromagnetic radiation ray irradiation section such that the optimal permeability amount Vx when the ink permeates into the recording medium satisfies a relation:
Vr≦Vx≦0.3 Vmax.

3. An ink jet recording apparatus according to claim 1, wherein the electromagnetic radiation ray irradiation time control means includes a moving mechanism for relatively moving the ink jet recording head and the electromagnetic radiation ray irradiation section in the relative moving direction of the ink recording head and the recording medium, the moving mechanism adjusts the relative distance between the ink jet recording head and the electromagnetic radiation irradiation section by the moving mechanism.

4. An ink jet recording apparatus according to claim 1, further comprising a recording medium moving mechanism for conveying the recording medium for relatively moving the ink jet recording head and the electromagnetic radiation irradiation section to the recording medium,
wherein the electromagnetic radiation ray irradiation time control means varies the moving speed of the recording medium to the electromagnetic radiation ray irradiation Section by the recording medium moving mechanism so as to vary the time to the irradiation of the electromagnetic radiation rays to the ink by the electromagnetic radiation rays irradiation section.

5. An ink jet recording apparatus according to claim 1, wherein the electromagnetic radiation rays curable ink is a UV-ray curable ink which is cured by the irradiation of UV-rays.

6. An ink jet recording apparatus according to claim 1, wherein the electromagnetic radiation curable ink contains an ingredient of lowering the viscosity.
